(19) United States
(12) Patent Application Publication
(10) Pub. No.: US 2011/0080243 A1
(43) Pub. Date: Apr. 7, 2011

(54) Inductor

(76) Inventor: Jen-Chien Lo, Xizhi City (TW)

(21) Appl. No.: 12/892,984

(22) Filed: Sep. 29, 2010

(30) Foreign Application Priority Data
Oct. 2, 2009 (TW) 098218280

(51) Int. Cl. H01F 27/04

(52) U.S. Cl. 336/90

(57) ABSTRACT

An inductor includes a hollow outer housing, an inner magnetic core, and a coil wound around the inner magnetic core. The outer housing includes two spaced sidewalls. The inner magnetic core and the coil are received in the outer housing, and a gap is defined between each of two ends of the inner magnetic core and one of the sidewalls of the outer housing in a length direction. Two wire ends of the coil extend out of the outer housing. The inner magnetic core is provided with at least one slot extending from an upper portion thereof through a lower portion thereof in a vertical direction perpendicular to the length direction, so that the inductor can, under low loading or small current, have a higher inductance to generate larger ripple rejection capability and to reduce the loss of a power module.

### BACKGROUND OF THE INVENTION

1. Field of the Invention

The present invention relates to an inductor and, more particularly, to a choke coil adapted to filter wave, to reject noise, and/or to resist electromagnetic interference.

2. Description of the Related Art

An inductor is widely used in networks, telecommunication, computers, AC power supplies and peripheral equipment to filter wave, to reject noise and/or to resist electromagnetic interference (EMI). Conventional inductors generally include a metallic coil that is wound into a helix shape, and an outer surface of the coil is coated with insulation film to form an insulated wire such as an enameled wire. An inner magnetic core formed by iron powder or ferrite material is received in the coil. The coil and the inner magnetic core are received within an outer housing that is used as a shielding case and generally made up of ferrite material. There is usually an air gap between the outer housing and the inner magnetic core to prevent the core from saturating. However, higher inductance value may not be provided to generate larger ripple rejection capability when the power supply circuit provides a small current, resulting in high loss of the power module and low working efficiency. On the other hand, saturation as well as overheating could usually happen in the ferrite core with an air gap when the power supply circuit provides a high current.

### BRIEF SUMMARY OF THE INVENTION

Therefore, it is an objective of the present invention to overcome the aforementioned shortcoming and deficiency of the prior art by providing an inductor that facilitates the control of the shape of current saturation curve and has a high mass production yield rate. In addition, at lower loading or small current, the inductor can have a higher inductance value so as to generate larger ripple rejection capability. Thus, the loss of a power module is greatly reduced and the working efficiency is enhanced.

To achieve the foregoing objective, an inductor of the present invention includes an outer housing, an inner magnetic core, and a coil. The outer housing includes a compartment defined therein and two sidewalls spaced in a length direction. The inner magnetic core is received in the compartment of the outer housing and includes first and second ends spaced in the length direction and respectively facing the sidewalls of the outer housing. A gap is defined between each of the first and second ends of the inner magnetic core and one of the sidewalls of the outer housing in the length direction. The inner magnetic core further includes upper and lower portions spaced in a vertical direction perpendicular to the length direction. The inner magnetic core further includes a slot extending from the upper portion of the inner magnetic core through the lower portion of the inner magnetic core. The coil is wound around the inner magnetic core in the length direction and received in the compartment of the outer housing. The coil includes first and second wire ends extending out of the outer housing.

In a preferred form, the slot of the inner magnetic core has square cross sections and extends in the vertical direction.

Preferably, the slot is located in a central portion between the first and second ends of the inner magnetic core in the length direction.

Preferably, the outer housing further includes upper and lower ends spaced in the vertical direction. An opening is formed in the upper end of the outer housing and a bottom wall formed on the lower end of the outer housing. The first and second wire ends of the coil extend out of the upper end of the outer housing through the opening.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of an inductor according to a first embodiment of the present invention;

FIG. 2 shows an exploded, perspective view of the inductor of FIG. 1;

FIG. 3 is a cross sectional view taken along plane 3-3 in FIG. 2;

FIG. 4 is a cross sectional view taken along plane 4-4 in FIG. 1; and

FIG. 5 shows a cross sectional view of an inductor according to a second embodiment of the present invention.

### DETAILED DESCRIPTION OF THE INVENTION

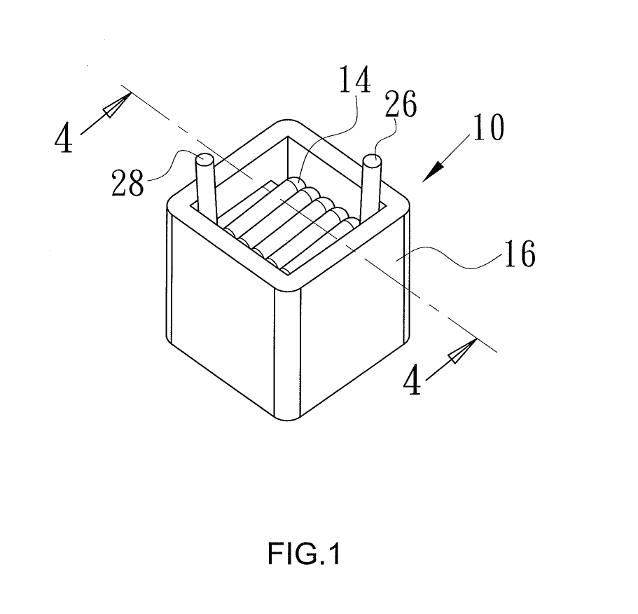

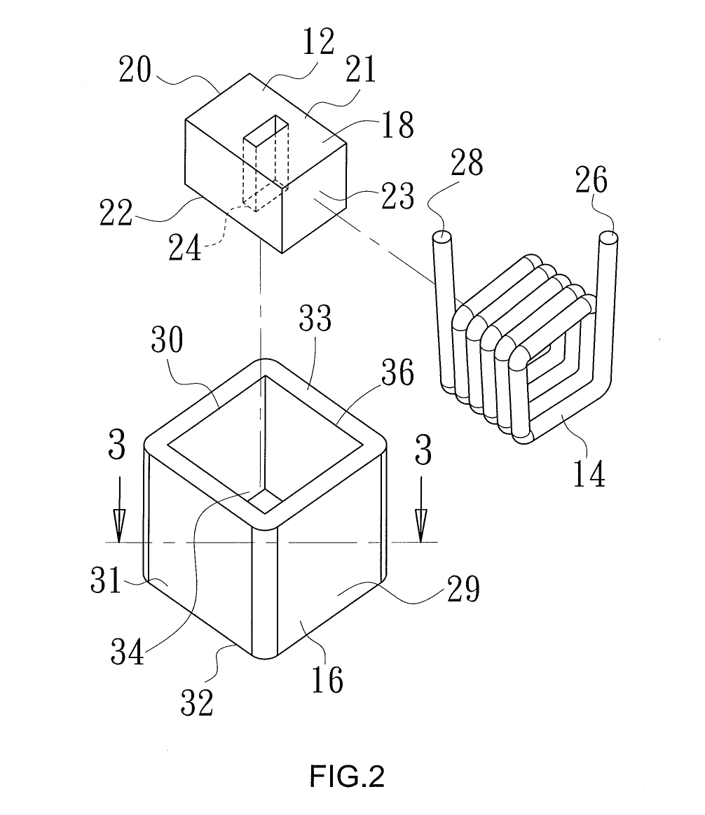

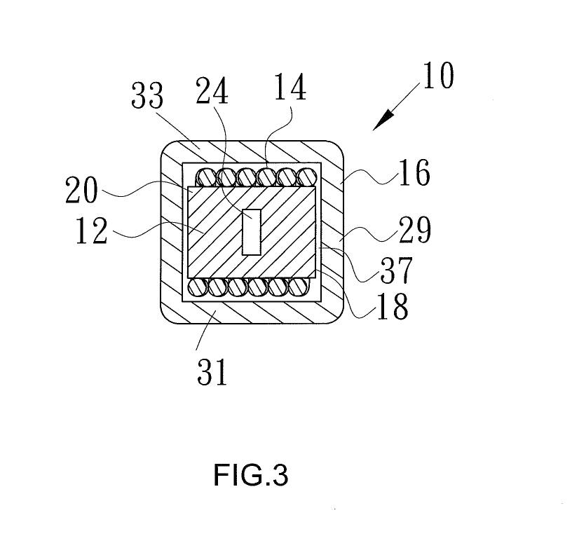

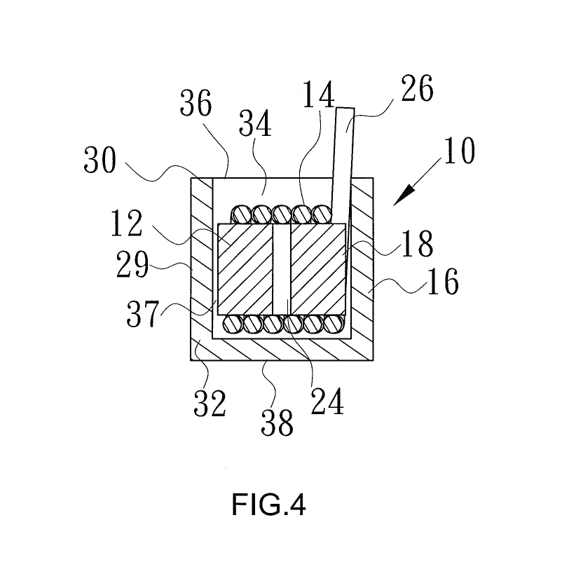

An inductor of a first embodiment of the present invention is shown in FIGS. 1 through 4 of the drawings and generally designated 10. The inductor 10 is adapted for use in, for example, networks, telecommunication, computers, or AC power supplies to filter wave, to reject noise, and/or to resist electromagnetic interference. Inductor 10 includes an inner magnetic core 12, a coil 14, and a hollow outer housing 16.

In this embodiment, inner magnetic core 12 is a square column made up of ferrite magnetic material and includes first and second ends 18 and 20 spaced in a length direction. Inner magnetic core 12 further includes upper and lower portions 21 and 22 spaced in a vertical direction perpendicular to the length direction. Inner magnetic core 12 further includes a slot 24 extending from upper portion 21 of inner magnetic core 12 through lower portion 22 of inner magnetic core 12 in the vertical direction. In this embodiment, slot 24 has square cross sections and is located in a central portion between first and second ends 18 and 20 of inner magnetic core 12 in the length direction.

In this embodiment, coil 14 is a helix shape wire covered with an insulation film and includes first and second wire ends 26 and 28. Coil 14 is wound around an outer periphery of inner magnetic core 12 along the length direction. In this embodiment, coil 14 is wound around inner magnetic core 12 for only one layer. Alternatively, coil 14 may be wound around inner magnetic core 12 for more than one layer.

Outer housing 16 is a shielding case made up of ferrite magnetic material and includes a compartment 34 defined therein. In this embodiment, outer housing 16 is a hollow cube and includes two sidewalls 29 spaced in the length direction. Outer housing 16 further includes upper and lower ends 30 and 32 spaced in the vertical direction and front and rear walls 31 and 33 spaced in a width direction perpendicular to the length and vertical directions. In this embodiment, an opening 36 is formed in upper end 30 of outer housing 16, and a bottom wall 38 is formed on lower end 32 of outer housing 16. Inner magnetic core 12 and coil 14 are received in compartment 34 of outer housing 16 through opening 36 such that first and second ends 18 and 20 of inner magnetic core 12 respectively face sidewalls 29 of outer housing 16. Wire ends 26 and 28 of coil 14 extend out of outer housing 16 through opening 36 so as to be connected to a power circuit (not shown). Coil 14 can be, through adhesive, engaged with front and rear walls 31 and 33 of outer housing 16 so as to maintain the stability of inductance. After inner magnetic core 12 and coil 14 are placed in outer housing 16, dielectric packaging material (for example, epoxy resin) can be injected into compartment 34 to position inner magnetic core 12 and coil 14 in place.

In accordance with the present invention, a gap 37 is defined between each of first and second ends 18 and 20 of inner magnetic core 12 and one of the sidewalls 29 of outer housing 16 in the length direction when inner magnetic core 12 and coil 14 are placed into compartment 34 of outer housing 16. In this embodiment, each gap 37 is about 0.05-0.15 mm so that respective air gaps are formed between first and second ends 18 and 20 of inner magnetic core 12 and sidewalls 29 of outer housing 16 to prevent inner magnetic core 12 from saturating. Further, with slot 24 of inner magnetic core 12, the shape of the saturation curve of inductor 10 can be controlled and adjusted. Specifically, without slot 24 provided in inner magnetic core 12, inductance characteristic will get to fast transition and drop when the inner magnetic core 12 of inductor 10 gets close to saturation; but with slot 24 provided in inner magnetic core 12, inductance characteristic can be buffered when inner magnetic core 12 gets close to saturation. Furthermore, through the adjustment of shape and location of slot 24, the shape of the current saturation curve can be controlled easily. Further, inductor 10 can have a higher inductance value at smaller current to generate larger ripple rejection capability, thereby reducing the loss of the power module and enhancing the working efficiency.

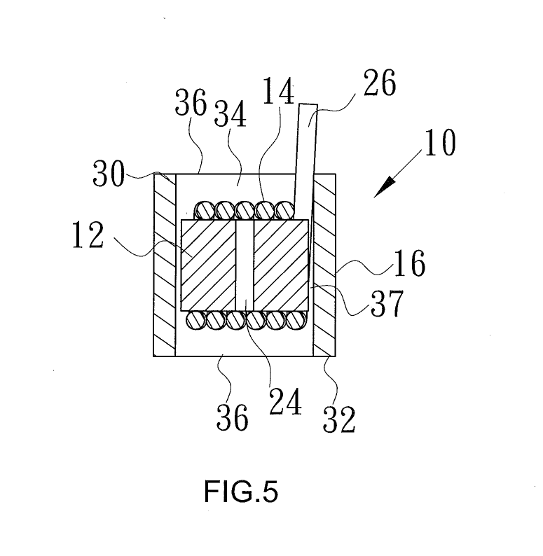

Now that the basic teachings of the present invention have been explained, many extensions and variations will be obvious to one having ordinary skill in the art. The inductor 10 shown in FIG. 5 is a modification of that shown in FIGS. 1 through 4. Description of the parts of inductor 10 shown in FIG. 5 identical to those shown in FIGS. 1 through 4 is omitted. In particular, the outer housing 16 in this embodiment includes two openings 36 formed in each of the upper and lower ends 30 and 32 of the outer housing 16.

It can be appreciated that slot 24 in inner magnetic core 12 can extend in the width direction instead of extending in the vertical direction, and slot 24 is not limited to extend through inner magnetic core 12. However, inductor 10 will have better inductance characteristic and better yield rate of mass production with slot 24 extending from the upper portion 21 of the inner magnetic core 12 through the lower portion 22 of the inner magnetic core 12 in the vertical direction.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An inductor comprising, in combination:
an outer housing including a compartment defined therein, with the outer housing including two sidewalls spaced in a length direction;
an inner magnetic core received in the compartment of the outer housing, with the inner magnetic core including first and second ends spaced in the length direction and respectively facing the two sidewalls of the outer housing, with a gap defined between each of the first and second ends of the inner magnetic core and one of the sidewalls of the outer housing in the length direction, with the inner magnetic core further including upper and lower portions spaced in a vertical direction perpendicular to the length direction, with the inner magnetic core further including a slot extending from the upper portion of the inner magnetic core through the lower portion of the inner magnetic core; and
a coil wound around the inner magnetic core and received in the compartment of the outer housing, and with the coil including first and second wire ends extending out of the outer housing.

2. The inductor according to claim 1, with the slot of the inner magnetic core having square cross sections and extending in the vertical direction.

3. The inductor according to claim 2, with the slot located in a central portion between the first and second ends of the inner magnetic core in the length direction.

4. The inductor according to claim 3, with the outer housing further including upper and lower ends spaced in the vertical direction, with the outer housing further including an opening formed in the upper end of the outer housing and a bottom wall formed on the lower end of the outer housing, and with the first and second wire ends of the coil extend out of the upper end of the outer housing through the opening.

5. The inductor according to claim 4, with the inner magnetic core being a square column made up of ferrite magnetic material, with the outer housing being a hollow cube made up of ferrite magnetic material, with the outer housing further including front and rear walls spaced in a width direction perpendicular to the length and vertical directions, and with the coil engaged with the front and rear walls of the outer housing.

6. The inductor according to claim 3, with the outer housing further including upper and lower ends spaced in the vertical direction, with the outer housing further including an opening formed in each of the upper and lower ends of the outer housing, and with the first and second wire ends of the coil extend out of the upper end of the outer housing.

7. The inductor according to claim 6, with the inner magnetic core being a square column made up of ferrite magnetic material, with the outer housing being a hollow cube made up of ferrite magnetic material, with the outer housing further including front and rear walls spaced in a width direction perpendicular to the length and vertical directions, and with the coil engaged with the front and rear walls of the outer housing.
